(19) United States
(12) Patent Application Publication
(10) Pub. No.: US 2024/0245989 A1
(43) Pub. Date: Jul. 25, 2024

(54) INFORMATION PROCESSING DEVICE AND VIBRATION CONTROL METHOD

(71) Applicants: Sony Interactive Entertainment Inc., Tokyo (JP); Sony Interactive Entertainment LLC, San Mateo, CA (US)

(72) Inventors: Charles WANG, San Mateo, CA (US); Yurika MULASE, Tokyo (JP); Shingo KUROKAWA, Tokyo (JP); Satish UPPULURI, Dublin, CA (US); Fumiaki HISAMATSU, Tokyo (JP); Takashi SAWADA, Tokyo (JP); Midori UENO, Tokyo (JP); Brian PARSONS, Oakland, CA (US); Max LOEB, San Francisco, CA (US); Dmitrijs JONINS, San Francisco, CA (US)

(73) Assignees: Sony Interactive Entertainment Inc., Tokyo (JP); Sony Interactive Entertainment LLC, San Mateo, CA (US)

(21) Appl. No.: 18/415,860

(22) Filed: Jan. 18, 2024

Related U.S. Application Data
(60) Provisional application No. 63/481,217, filed on Jan. 24, 2023.

(51) Int. Cl. A63F 13/285; A63F 13/22

(52) U.S. Cl. CPC A63F 13/285; A63F 13/22

(57) ABSTRACT

Disclosed herein is an information processing device that is connected, in a wireless or wired manner, to an input device including a left-side holding part having a left-side vibrator and a right-side holding part having a right-side vibrator, the information processing device including one or more processors having hardware. The one or more processors arrange a focus in a screen, receive directional input transmitted from the input device, move the focus on the basis of the received directional input, and cause the left-side vibrator and/or the right-side vibrator to vibrate according to the movement of the focus.

### CROSS REFERENCE TO RELATED APPLICATIONS

This application claims priority to a U.S. Provisional Application, Serial No. 63/481,217, filed on Jan. 24, 2023, which is herein incorporated by reference in its entirety.

### BACKGROUND

The present disclosure relates to a technique for controlling electronic equipment such as a game controller having a vibrator.

In recent years, game controllers having vibrators have become popular. Japanese Patent Laid-Open No. 2007-244534 discloses a game system including a game controller having a vibrator and a game device that transmits a vibration control signal to the game controller according to a progressing status of a game. In this game system, the vibrator mounted on the game controller vibrates on the basis of the vibration control signal provided from a game program and provides feedback of the game play to the user.

### SUMMARY

In developing a user interface, the present discloser has focused on the applicability of the vibrator mounted on the game controller. It is desirable to provide a technique that improves user accessibility by using the vibrator.

According to an embodiment of the present disclosure, there is provided an information processing device that is connected, in a wireless or wired manner, to an input device including a left-side holding part having a left-side vibrator and a right-side holding part having a right-side vibrator, the information processing device including one or more processors having hardware. The one or more processors arrange a focus in a screen, receive directional input transmitted from the input device, move the focus on the basis of the received directional input, and cause the left-side vibrator and/or the right-side vibrator to vibrate according to the movement of the focus.

According to another embodiment of the present disclosure, there is provided a method of controlling vibration of a vibrator in an information processing device that is connected, in a wireless or wired manner, to an input device including a left-side holding part having a left-side vibrator and a right-side holding part having a right-side vibrator, the method including arranging a focus in a screen, receiving directional input transmitted from the input device, moving the focus on the basis of the received directional input, and causing the left-side vibrator and/or the right-side vibrator to vibrate according to the movement of the focus.

According to still another embodiment of the present disclosure, there is provided an information processing device that is connected, in a wireless or wired manner, to electronic equipment including a vibrator, the information processing device including a storage unit that holds information indicating whether a vibration function related to a game play is enabled or disabled and one or more processors having hardware. The one or more processors receive a user operation to enable a vibration function related to a user interface, enable the vibration function related to the user interface if the information indicating that the vibration function related to the game play is enabled is held in the storage unit, and cause the vibrator to vibrate when the user interface is displayed.

According to still another embodiment of the present disclosure, there is provided a method of controlling vibration of a vibrator in an information processing device that is connected, in a wireless or wired manner, to electronic equipment including the vibrator, the method including holding information indicating whether a vibration function related to a game play is enabled or disabled, receiving a user operation to enable a vibration function related to a user interface, if the information indicating that the vibration function related to the game play is enabled is held, enabling the vibration function related to the user interface, and causing the vibrator to vibrate when the user interface is displayed.

It should be noted that any combinations of the above constitutional elements, and those obtained by converting expressions of the present disclosure between methods, devices, systems, recording media, computer programs, and the like are also valid as an embodiment of the present disclosure.

### BRIEF DESCRIPTION OF THE DRAWINGS

FIG. 1 is a diagram for illustrating an information processing system according to an embodiment;

FIG. 2 is a top view of an input device;

FIG. 3 is a perspective view of the input device;

FIG. 4 is a diagram for illustrating functional blocks of the input device;

FIG. 5 is a diagram for illustrating a hardware configuration of an information processing device;

FIG. 6 is a diagram for illustrating functional blocks of the information processing device;

FIG. 7 is a diagram for illustrating an example of a menu screen;

FIG. 8 is a diagram for illustrating an example of the menu screen in which a focus has been moved;

FIG. 9 is a diagram for illustrating examples of moving directions of the focus and vibrating modes of vibrators;

FIG. 10 is a diagram for illustrating examples of vibration intensities of left and right vibrators;

FIG. 11 is a diagram for illustrating another example of a user interface screen;

FIG. 12 is a diagram for illustrating an example of a game screen;

FIG. 13 is a diagram for illustrating an example of a notification superimposed and displayed on the game screen;

FIG. 14 is a diagram for illustrating an example of an accessibility setting screen;

FIG. 15 is a diagram for illustrating an example of a screen for setting a vibration function related to the user interface;

FIG. 16 is a diagram for illustrating another example of the accessibility setting screen;

FIG. 17 is a diagram for illustrating an example of a screen for setting the vibration function related to the user interface;

FIG. 18 is a diagram for illustrating an example of a dialog superimposed and displayed on the setting screen; and

FIG. 19 is a diagram for illustrating an example of the setting screen.

### DETAILED DESCRIPTION OF THE PREFERRED EMBODIMENT

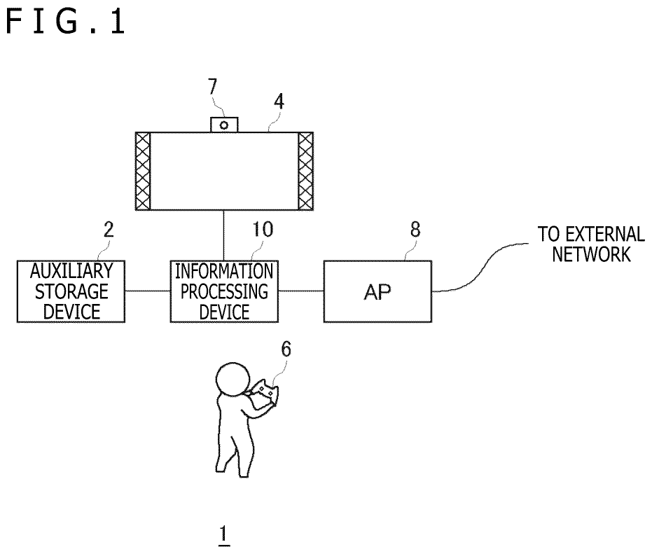

FIG. 1 illustrates an information processing system 1 according to an embodiment of the present disclosure. The information processing system 1 includes an information processing device 10 that is a user terminal device, an auxiliary storage device 2, and an output device 4. An access point (hereinafter, referred to as an “AP”) 8 has functions of a wireless access point and a router, and the information processing device 10 is connected to the AP 8 in a wireless or wired manner.

The information processing device 10 is connected to an input device 6 operated by a user in a wireless or wired manner, and the input device 6 transmits information regarding an operation performed by the user to the information processing device 10. When receiving the operation information from the input device 6, the information processing device 10 reflects it in processing of system software or game software and outputs the processing result from the output device 4.

In the embodiment, the information processing device 10 is a game device (game console) that executes a game program, and the input device 6 may be electronic equipment such as a game controller that supplies the operation information of the user to the information processing device 10. It should be noted that the input device 6 may be an input interface such as a keyboard or a mouse.

The auxiliary storage device 2 is a large-capacity storage device such as a hard disk drive (HDD) or a solid state drive (SSD) and may be a built-in storage device, or may be an external storage device connected to the information processing device 10 via a universal serial bus (USB) or the like. The output device 4 may be a television having a display device that outputs images and a speaker that outputs voices. The output device 4 may be connected to the information processing device 10 via a wired cable or may be connected wirelessly.

A camera 7, which is an imaging device, is provided near the output device 4 and images the space around the output device 4. Although FIG. 1 illustrates an example in which the camera 7 is mounted at an upper part of the output device 4, it may be arranged at a side part or a lower part of the output device 4, and in any case, is arranged at such a position that the user positioned in front of the output device 4 can be imaged by the camera 7. The camera 7 may be a stereo camera.

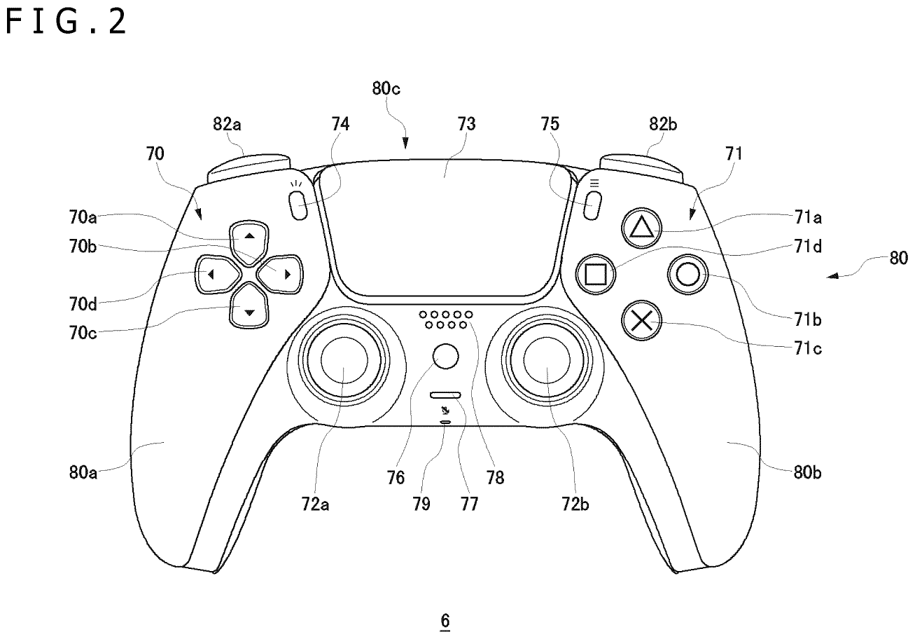

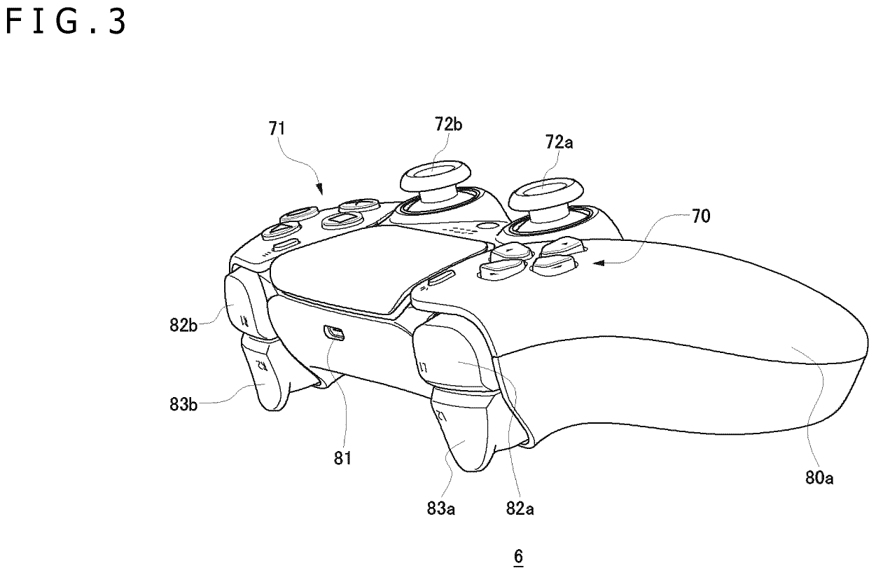

FIG. 2 illustrates a top view of the input device, and FIG. 3 illustrates a perspective view of the input device. The input device 6 includes a housing 80 that has a left-side holding part 80a, a right-side holding part 80b, and a central housing part 80c. The left-side holding part 80a and the right-side holding part 80b are provided in such a manner as to sandwich the central housing part 80c therebetween, the left-side holding part 80a is held by the left hand of the user, and the right-side holding part 80b is held by the right hand of the user. A vibrator for presenting a tactile sense to the hand of the user is provided in each of inner spaces at ends of the left-side holding part 80a and the right-side holding part 80b.

Various operators to be operated by the user are arranged in the central housing part 80c. On an upper surface of the central housing part 80c, provided are direction keys 70, action buttons 71, a left analog stick 72a, a right analog stick 72b, a touchpad 73, a create button 74, an option button 75, a home button 76, a mute button 77, a speaker 78, and a microphone 79. The direction keys 70 include an upper key 70a, a right key 70b, a lower key 70c, and a left key 70d, and the action buttons 71 include a triangle button 71a, a circle button 71b, a cross button 71c, and a square button 71d. The left analog stick 72a doubles as an L3 button that is turned on when being pressed, and similarly, the right analog stick 72b doubles as an R3 button that is turned on when being pressed. In addition, the touchpad 73 also functions as a touchpad button that is turned on when being pressed.

On a back surface of the central housing part 80c, provided are a USB terminal 81, an L1 button 82a, an R1 button 82b, an L2 button 83a, and an R2 button 83b. The L2 button 83a and the R2 button 83b are trigger-type buttons and are connected to actuators that dynamically change resistance generated when the user presses the trigger-type buttons with fingers. For example, when the pressing resistance of the L2 button 83a and/or the R2 button 83b is dynamically changed by an action in a game, the presence of the game is enhanced.

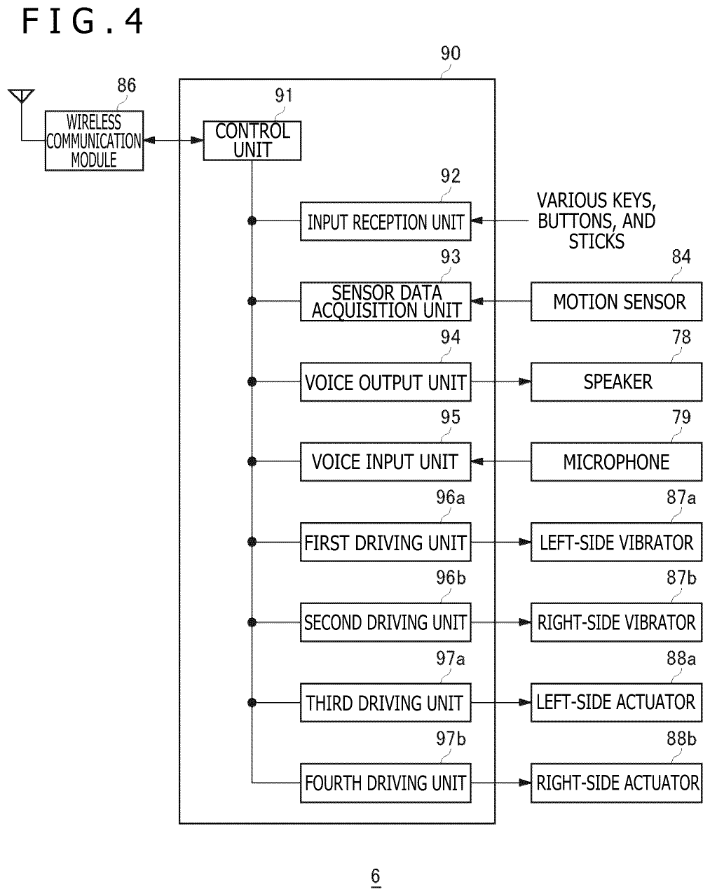

FIG. 4 illustrates functional blocks of the input device. The input device 6 includes a wireless communication module 86, a processing unit 90, a motion sensor 84, the speaker 78, the microphone 79, a left-side vibrator 87a, a right-side vibrator 87b, a left-side actuator 88a, and a right-side actuator 88b inside the housing 80. The wireless communication module 86 has a function of transmitting and receiving data to and from a wireless communication module of the information processing device 10. The input device 6 is equipped with a battery, which is not illustrated, and each configuration in the input device 6 is operated by receiving power supply from the battery.

The processing unit 90 has a control unit 91, an input reception unit 92, a sensor data acquisition unit 93, a voice output unit 94, a voice input unit 95, a first driving unit 96a, a second driving unit 96b, a third driving unit 97a, and a fourth driving unit 97b. The control unit 91 performs various kinds of processing in the input device 6.

The input reception unit 92 receives the operation information of the user from the input units such as the direction keys 70, the action buttons 71, the left analog stick 72a, the right analog stick 72b, the touchpad 73, the create button 74, the option button 75, the home button 76, the mute button 77, the L1 button 82a, the R1 button 82b, the L2 button 83a, and the R2 button 83b and sends it to the control unit 91. The control unit 91 supplies the received operation information to the wireless communication module 86, and the wireless communication module 86 transmits the operation information to the information processing device 10.

The motion sensor 84 has a three-axis acceleration sensor and a three-axis gyro sensor. The three-axis acceleration sensor detects acceleration in three axis directions, that is, x, y, and z, and the three-axis gyro sensor detects angular velocities in an xz plane, a zy plane, and a yx plane. The three-axis acceleration sensor and the three-axis gyro sensor may be arranged at positions near the center in the housing 80. The motion sensor 84 detects the acceleration and the angular velocity at a predetermined cycle, and when the sensor data acquisition unit 93 acquires sensor data detected by the motion sensor 84, the control unit 91 supplies the sensor data to the wireless communication module 86, and the wireless communication module 86 transmits the sensor data to the information processing device 10.

When the wireless communication module 86 receives voice data from the information processing device 10, the control unit 91 supplies the voice data to the voice output unit 94, and the voice output unit 94 outputs the voice from the speaker 78. When the voice input unit 95 receives voice data of the user from the microphone 79, the control unit 91 supplies the user voice data to the wireless communication module 86, and the wireless communication module 86 transmits the user voice data to the information processing device 10. Since the input device 6 includes the speaker 78 and the microphone 79, the user can enjoy a voice chat with a friend.

The left-side vibrator 87a is built in a protruding end of the left-side holding part 80a, and the right-side vibrator 87b is built in a protruding end of the right-side holding part 80b. The left-side vibrator 87a and the right-side vibrator 87b (hereinafter, referred to as a “vibrator 87” in some cases when they are not particularly distinguished from each other) can present a tactile sense to the hands of the user by being built in ends of grip parts that are held by the hands of the user. The vibrator 87 may include a vibrating motor having an eccentric weight.

When receiving a control signal for the left-side vibrator 87a and a control signal for the right-side vibrator 87b from the information processing device 10, the wireless communication module 86 supplies the signals to the control unit 91, and the control unit 91 controls the first driving unit 96a on the basis of the control signal for the left-side vibrator 87a and the second driving unit 96b on the basis of the control signal for the right-side vibrator 87b. The first driving unit 96a and the second driving unit 96b (hereinafter, referred to as a “driving unit 96” in some cases when they are not particularly distinguished from each other) may be configured as pulse width modulation (PWM) control units that vary a duty ratio of a voltage supplied to each of the left-side vibrator 87a and the right-side vibrator 87b. In this case, the control signal for the left-side vibrator 87a fixes the duty ratio of the voltage to be supplied to the left-side vibrator 87a, and the control signal for the right-side vibrator 87b fixes the duty ratio of the voltage to be supplied to the right-side vibrator 87b. Since an intensity at which the vibrator 87 vibrates becomes higher when the duty ratio of the voltage supplied to the vibrator 87 by the driving unit 96 is high and the intensity at which the vibrator 87 vibrates becomes lower when the duty ratio of the supplied voltage is low, the information processing device 10 can cause the vibrator 87 to vibrate at a desired vibration intensity by adjusting the duty ratio of the supplied voltage.

The left-side actuator 88a is coupled to the L2 button 83a, and the right-side actuator 88b is coupled to the R2 button 83b. The left-side actuator 88a and the right-side actuator 88b (hereinafter, referred to as an “actuator 88” in some cases when they are not particularly distinguished from each other) apply resistance to the respective fingers of the user that press the respective L2 button 83a and R2 button 83b. The actuator 88 has a structure that applies a resistance force against pressing forces of the L2 button 83a and the R2 button 83b.

When receiving a control signal for the left-side actuator 88a and a control signal for the right-side actuator 88b from the information processing device 10, the wireless communication module 86 supplies the signals to the control unit 91, and the control unit 91 controls the third driving unit 97a on the basis of the control signal for the left-side actuator 88a and the fourth driving unit 97b on the basis of the control signal for the right-side actuator 88b. The third driving unit 97a and the fourth driving unit 97b (hereinafter, referred to as a “driving unit 97” in some cases when they are not particularly distinguished from each other) may be configured as PWM control units that vary a duty ratio of a voltage supplied to each of the left-side actuator 88a and the right-side actuator 88b. In this case, the control signal for the left-side actuator 88a fixes the duty ratio of the voltage to be supplied to the left-side actuator 88a, and the control signal for the right-side actuator 88b fixes the duty ratio of the voltage to be supplied to the right-side actuator 88b. Since the resistance force generated by the actuator 88 becomes stronger when the duty ratio of the voltage supplied to the actuator 88 by the driving unit 97 is high and the resistance force generated by the actuator 88 becomes weaker when the duty ratio of the supplied voltage is low, the information processing device 10 can generate a desired resistance force in the actuator 88 by adjusting the duty ratio of the supplied voltage.

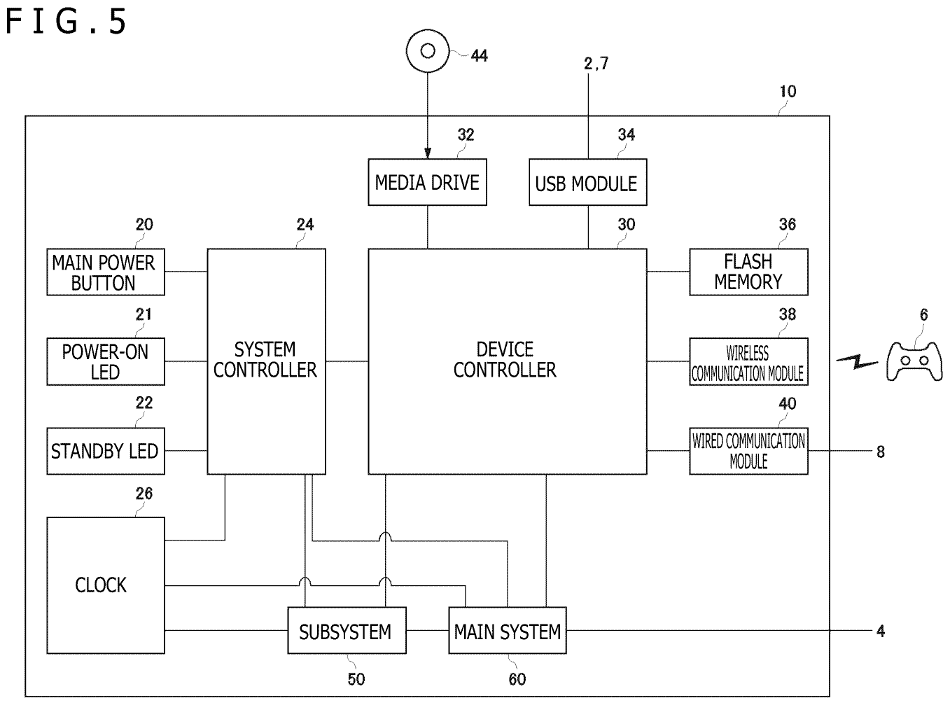

FIG. 5 illustrates a hardware configuration of the information processing device 10. The information processing device 10 has a main power button 20, a power-on light emitting diode (LED) 21, a standby LED 22, a system controller 24, a clock 26, a device controller 30, a media drive 32, a USB module 34, a flash memory 36, a wireless communication module 38, a wired communication module 40, a subsystem 50, and a main system 60.

The main system 60 includes a main central processing unit (CPU), a memory as a main storage device, a memory controller, a graphics processing unit (GPU), and the like. The GPU is mainly used for arithmetic processing of a game program. These functions may be configured as a system-on-chip and formed on a single chip. The main CPU has a function of executing a game program recorded in the auxiliary storage device 2 or a read only memory (ROM) medium 44.

The subsystem 50 includes a sub-CPU, a memory as a main storage device, a memory controller, and the like, does not include a GPU, and does not have a function of executing a game program. The number of circuit gates of the sub-CPU is smaller than that of the main CPU, and the operating power consumption of the sub-CPU is smaller than that of the main CPU. The sub-CPU operates even while the main CPU is in a standby state, and the processing functions thereof are limited in order to keep the power consumption low.

The main power button 20 is an input unit by which operational input from the user is made, and is provided on a front surface of a housing of the information processing device 10 and operated to turn on or off the power supply to the main system 60 of the information processing device 10. The power-on LED 21 lights when the main power button 20 is turned on, and the standby LED 22 lights when the main power button 20 is turned off.

The system controller 24 detects pressing of the main power button 20 by the user. If the main power button 20 is pressed when the main power is in the off state, the system controller 24 acquires the pressing operation as an “on instruction,” while, if the main power button 20 is pressed when the main power is in the on state, the system controller 24 acquires the pressing operation as an “off instruction.”

The clock 26 is a real-time clock that generates current date and time information and supplies it to the system controller 24, the subsystem 50, and the main system 60. The device controller 30 is configured as a large-scale integrated circuit (LSI) that executes transfer of information between devices like a south bridge. As illustrated in the drawing, the devices such as the system controller 24, the media drive 32, the USB module 34, the flash memory 36, the wireless communication module 38, the wired communication module 40, the subsystem 50, and the main system 60 are connected to the device controller 30. The device controller 30 absorbs differences in electrical characteristics of the respective devices and differences in data transfer speed to control timings of the data transfer.

The media drive 32 is a drive device that is driven by being loaded with the ROM medium 44 having recorded therein application software such as a game and license information, and reads programs, data, and the like from the ROM medium 44. The ROM medium 44 may be a read-only recording medium such as an optical disk, a magneto-optical disk, or a Blu-ray disk.

The USB module 34 is a module that is connected to external equipment via a USB cable. The USB module 34 may be connected to the auxiliary storage device 2 and the camera 7 via a USB cable. The flash memory 36 is an auxiliary storage device configuring an inner storage. The wireless communication module 38 communicates wirelessly with, for example, the input device 6 by using a communication protocol such as the Bluetooth (registered trademark) protocol or the IEEE 802.11 protocol. The wired communication module 40 performs wired communication with external equipment and is connected to an external network via the AP 8.

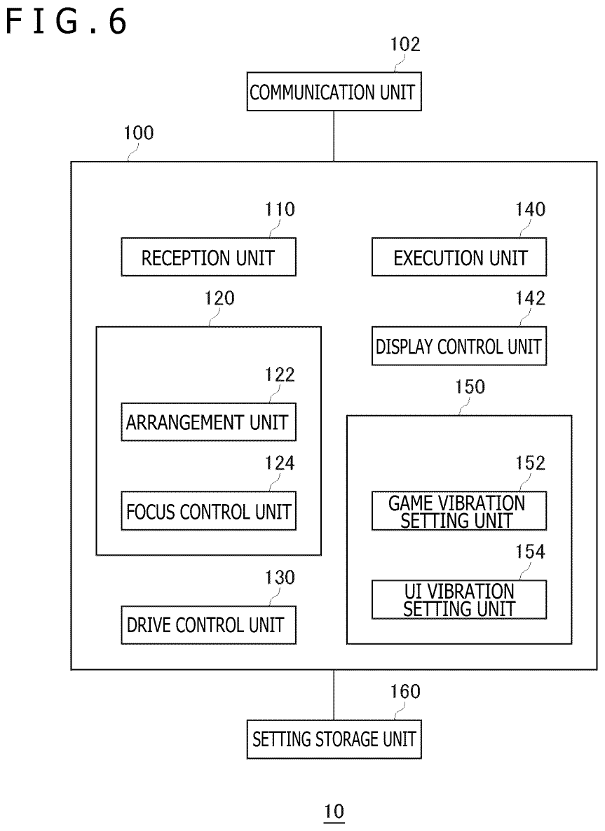

FIG. 6 illustrates functional blocks of the information processing device 10. The information processing device 10 includes a processing unit 100, a communication unit 102, and a setting storage unit 160, and the processing unit 100 includes a reception unit 110, a menu image generation unit 120, a drive control unit 130, an execution unit 140, a display control unit 142, and a setting unit 150. The menu image generation unit 120 has an arrangement unit 122 and a focus control unit 124, and the setting unit 150 has a game vibration setting unit 152 and a user interface (UI) vibration setting unit 154. The setting storage unit 160 is a memory or a storage and may be configured in the flash memory 36, the auxiliary storage device 2, or the like.

The information processing device 10 illustrated in FIG. 6 includes a computer, and various functions illustrated in FIG. 6 are realized by the computer executing programs. The computer includes, as hardware, a memory that loads a program, one or more processors that execute the loaded program, an auxiliary storage device, other LSIs, and the like. The processor includes a plurality of electronic circuits including semiconductor integrated circuits and LSIs, and the plurality of electronic circuits may be mounted on a single chip or on a plurality of chips. It can be understood by those skilled in the art that the functional blocks illustrated in FIG. 6 are realized by cooperation of hardware and software and that these functional blocks can therefore be realized in various forms by hardware alone, software alone, or a combination thereof.

The communication unit 102 is expressed as a configuration that has the combined functions of the wireless communication module 38 and the wired communication module 40 illustrated in FIG. 5. The communication unit 102 receives the operation information regarding an operation performed on an input unit of the input device 6 by the user, and the reception unit 110 receives the operation information received by the communication unit 102.

The menu image generation unit 120 has a function of generating a menu image including a plurality of display elements. In the embodiment, the display elements included in the menu image may be graphical user interface (GUI) elements such as a game icon and an icon of an application other than the game. When the user selects a display element included in the menu screen and performs a decision operation on the selected display element, the execution unit 140 executes a function associated with the selected icon. For example, when a game icon is selected and a decision operation is performed, the execution unit 140 executes a game program associated with the selected icon to generate a game image and a game voice. The display control unit 142 causes the output device 4 to display the game image generated by the execution unit 140.

In the menu image generation unit 120, the arrangement unit 122 generates a menu image by arranging a plurality of icons on two-dimensional coordinates that configure the screen. The arrangement unit 122 may generate the menu image by using various user operations as a trigger, but, for example, when the main power button 20 is turned on and the information processing device 10 is activated, the arrangement unit 122 may generate the menu image, and the display control unit 142 may display the menu screen on the output device 4.

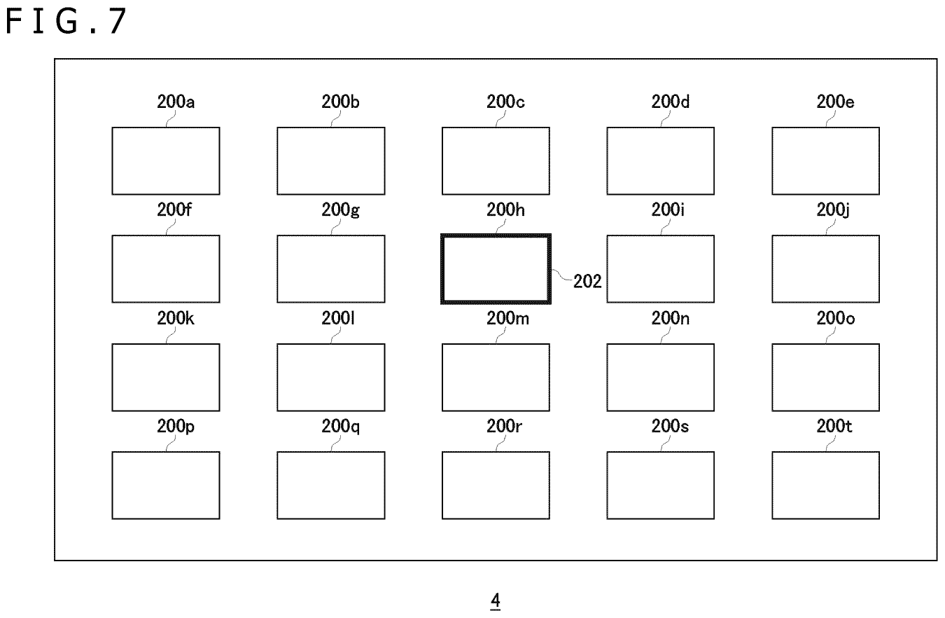

FIG. 7 illustrates an example of the menu screen displayed on the output device 4. The menu screen illustrated in FIG. 7 may be a user interface screen displayed on the output device 4 when the information processing device 10 is activated. The arrangement unit 122 generates a menu image in which a plurality of icons 200a, 200b, 200c, 200d, 200e, 200f, 200g, 200h, 200i, 200j, 200k, 200l, 200m, 200n, 200o, 200p, 200q, 200r, 200s, and 200t (hereinafter, referred to as an “icon 200” when they are not particularly distinguished from each other) are arranged. The arrangement unit 122 may arrange the plurality of icons 200 according to a predetermined layout (format). In the embodiment, the arrangement unit 122 arranges the icons 200 that are GUI components (GUI elements) associated with functions, but may arrange other types of display elements.

The focus control unit 124 gives a focus 202 to an icon 200 in a selected state. The focus 202 may be a display element for presenting to the user that the icon 200 is in the selected state, and the focus control unit 124 displays the selected icon 200 in a display mode different from that of unselected icons 200. In the menu screen illustrated in FIG. 7, the icon 200h arranged near the center of the screen is in the selected state, and the focus control unit 124 arranges the focus 202, which indicates the selected state, around the icon 200h. The user can recognize that the icon 200h is selected, by confirming the icon with the focus 202 given.

In this example, the focus 202 is the display element of a frame surrounding the icon 200. Other than the frame, the focus control unit 124 may display the icon 200h in the selected state larger than a standard size or flash the icon 200h itself, so that the user can recognize that the icon 200h is in the selected state. In the embodiment, changing the display mode of the icon 200h itself from a normal display mode is also called as giving a focus.

The input device 6 operated by the user includes the direction operators such as the direction keys 70 and/or the analog sticks for inputting directions. In the embodiment, the user operates the direction operators of the input device 6 to move the focus 202 to a desired icon 200.

When the user operates the direction operators of the input device 6 in a state where the menu screen is displayed on the output device 4, the reception unit 110 receives the direction input transmitted from the input device 6, as an operation to select the icon 200. The focus control unit 124 moves the focus 202 on the basis of the received direction input. At this time, the drive control unit 130 causes the left-side vibrator 87a and/or the right-side vibrator 87b in the input device 6 to vibrate according to the movement of the focus 202.

Specifically, the drive control unit 130 generates a control signal for causing the left-side vibrator 87a and/or the right-side vibrator 87b to vibrate and transmits it from the communication unit 102 to the input device 6. For example, the drive control unit 130 may generate control signals for causing both the left-side vibrator 87a and the right-side vibrator 87b to vibrate at the same vibration intensity, and transmit them from the communication unit 102 to the input device 6. When receiving the control signal for the left-side vibrator 87a and the control signal for the right-side vibrator 87b, the control unit 91 in the input device 6 controls the first driving unit 96a and the second driving unit 96b to cause the left-side vibrator 87a and the right-side vibrator 87b to vibrate at the same vibration intensity. When the left-side holding part 80a and the right-side holding part 80b vibrate, the user can recognize that the focus 202 has been moved.

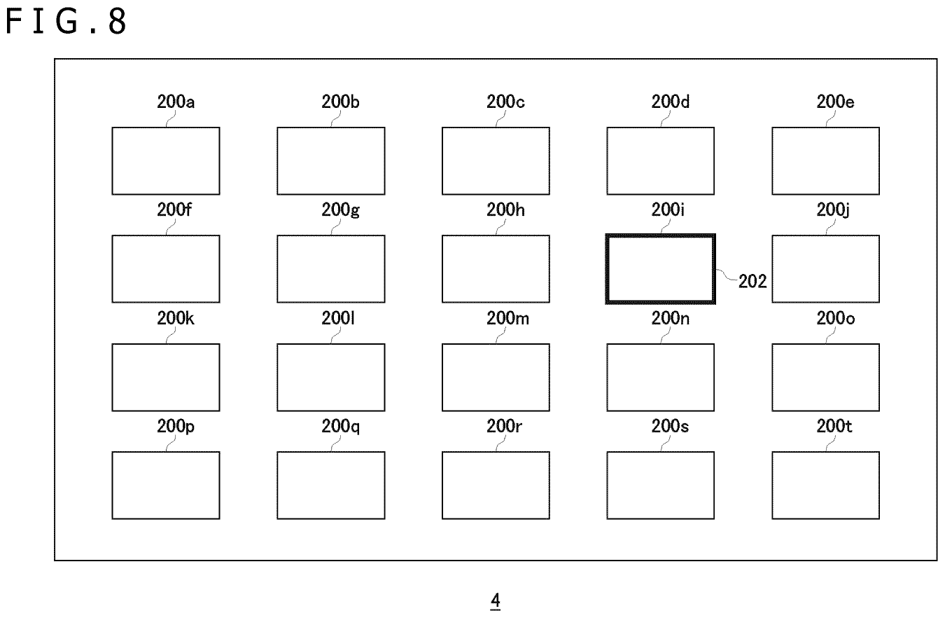

FIG. 8 illustrates an example of the menu screen in which the focus 202 has moved. In the menu screen illustrated in FIG. 8, the focus 202 is arranged to surround the icon 200i. When the reception unit 110 receives an operation of the right key 70b during the display of the menu screen illustrated in FIG. 7, the focus control unit 124 identifies the icon 200i selected by the operation of the right key 70b.

The plurality of icons 200 are arranged according to a predetermined layout by the arrangement unit 122, and the moving destination of the focus 202 when the direction keys are operated is defined at each position where the icon 200 is arranged. For example, at the position where the icon 200h is arranged, it is defined that the focus 202 is moved to the position of the icon 200c by an operation of the upper key 70a, the focus 202 is moved to the position of the icon 200i by an operation of the right key 70b, the focus 202 is moved to the position of the icon 200m by an operation of the lower key 70c, and the focus 202 is moved to the position of the icon 200g by an operation of the left key 70d.

The above is the description of the definition information of the moving destination when the direction operators are the upper, lower, left, and right direction keys 70, but in the case where the direction operators are analog sticks, the moving destination of the focus 202 may be defined by an angular range of the direction in which the analog sticks are tilted.

The focus control unit 124 identifies the position to be the moving destination of the focus 202 according to the definition information of the moving destination. When the reception unit 110 receives an operation of the right key 70b during the display of the menu screen illustrated in FIG. 7, the focus control unit 124 identifies the icon 200i to be selected by the operation of the right key 70b and arranges the focus 202 to surround the icon 200i.

In the embodiment, the drive control unit 130 may cause the left-side vibrator 87a and/or the right-side vibrator 87b to vibrate according to the moving direction of the focus 202.

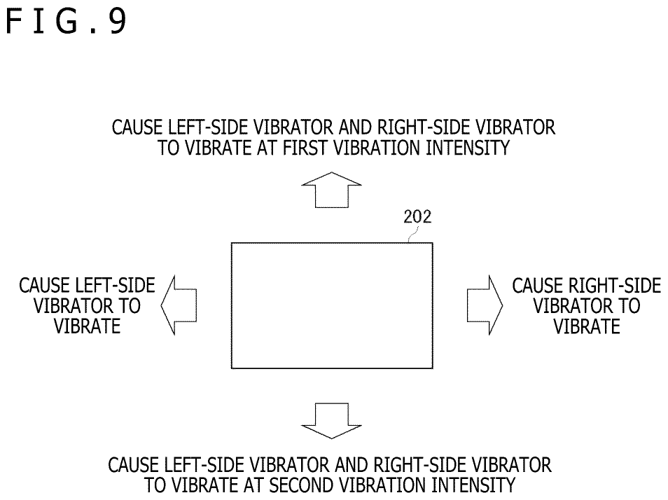

FIG. 9 illustrates examples of the moving directions of the focus 202 and vibrating modes of the vibrators. The drive control unit 130 may cause the left-side vibrator 87a to vibrate in the case where the focus 202 is moved to the left direction in the screen, and may cause the right-side vibrator 87b to vibrate in the case where the focus 202 is moved to the right direction in the screen. Therefore, in the menu screen illustrated in FIG. 7, when the focus 202 is moved leftward from the icon 200h to the icon 200g, the drive control unit 130 generates a control signal for causing the left-side vibrator 87a to vibrate, and when the focus 202 is moved rightward from the icon 200h to the icon 200i, the drive control unit 130 generates a control signal for causing the right-side vibrator 87b to vibrate.

In addition, in the case where the focus 202 is moved to the upper direction in the screen, the drive control unit 130 causes the left-side vibrator 87a and the right-side vibrator 87b to vibrate at a first vibration intensity, and in the case where the focus 202 is moved to the lower direction in the screen, the drive control unit 130 causes the left-side vibrator 87a and the right-side vibrator 87b to vibrate at a second vibration intensity different from the first vibration intensity. The second vibration intensity may be set lower than the first vibration intensity.

Hereinafter, for the convenience of explanation, the vibration intensity is defined as values between 0 and 100. A vibration intensity of 0 indicates a state where the vibrator 87 does not vibrate, and a vibration intensity of 100 indicates the maximum vibration intensity of the vibrator 87. When expressed as intensities (Ia, Ib), Ia expresses the vibration intensity of the left-side vibrator 87a, and Ib expresses the vibration intensity of the right-side vibrator 87b. For example, intensities (30, 70) indicate that the vibration intensity of the left-side vibrator 87a is 30 and the vibration intensity of the right-side vibrator 87b is 70.

In the case where the focus 202 is moved to the left direction in the screen, the drive control unit 130 generates a control signal as intensities (50, 0) and transmits it from the communication unit 102 to the input device 6. That is, the drive control unit 130 generates a control signal for causing the left-side vibrator 87a to vibrate at a vibration intensity of 50, and transmits it from the communication unit 102 to the input device 6. At this time, the drive control unit 130 does not generate a control signal for causing the right-side vibrator 87b to vibrate. When receiving the control signal for the left-side vibrator 87a, the control unit 91 in the input device 6 controls the first driving unit 96a to cause the left-side vibrator 87a to vibrate at a vibration intensity of 50. When the left-side holding part 80a vibrates, the user can recognize that the focus 202 has been moved leftward.

In the case where the focus 202 is moved to the right direction in the screen, the drive control unit 130 generates a control signal as intensities (0, 50) and transmits it from the communication unit 102 to the input device 6. That is, the drive control unit 130 generates a control signal for causing the right-side vibrator 87b to vibrate at a vibration intensity of 50, and transmits it from the communication unit 102 to the input device 6. At this time, the drive control unit 130 does not generate a control signal for causing the left-side vibrator 87a to vibrate. When receiving the control signal for the right-side vibrator 87b, the control unit 91 in the input device 6 controls the second driving unit 96b to cause the right-side vibrator 87b to vibrate at a vibration intensity of 50. When the right-side holding part 80b vibrates, the user can recognize that the focus 202 has been moved rightward.

In the case where the focus 202 is moved to the upper direction in the screen, the drive control unit 130 generates control signals as intensities (80, 80) and transmits them from the communication unit 102 to the input device 6. That is, the drive control unit 130 generates control signals for causing the left-side vibrator 87a and the right-side vibrator 87b to vibrate at a vibration intensity of 80, and transmits them from the communication unit 102 to the input device 6. When receiving the control signal for the left-side vibrator 87a and the control signal for the right-side vibrator 87b, the control unit 91 in the input device 6 controls the first driving unit 96a and the second driving unit 96b to cause the left-side vibrator 87a and the right-side vibrator 87b to vibrate at a vibration intensity of 80. When the left-side holding part 80a and the right-side holding part 80b strongly vibrate, the user can recognize that the focus 202 has been moved upward.

In the case where the focus 202 is moved to the lower direction in the screen, the drive control unit 130 generates control signals as intensities (20, 20) and transmits them from the communication unit 102 to the input device 6. That is, the drive control unit 130 generates control signals for causing the left-side vibrator 87a and the right-side vibrator 87b to vibrate at a vibration intensity of 20, and transmits them from the communication unit 102 to the input device 6. When receiving the control signal for the left-side vibrator 87a and the control signal for the right-side vibrator 87b, the control unit 91 in the input device 6 controls the first driving unit 96a and the second driving unit 96b to cause the left-side vibrator 87a and the right-side vibrator 87b to vibrate at a vibration intensity of 20. When the left-side holding part 80a and the right-side holding part 80b weakly vibrate, the user can recognize that the focus 202 has been moved downward.

In the above embodiment, the drive control unit 130 causes the vibrator 87 to vibrate according to the moving direction of the focus 202, but the drive control unit 130 may cause the vibrator 87 to vibrate according to the position to which the focus 202 is moved (the moving destination of the focus 202).

Specifically, the drive control unit 130 causes the left-side vibrator 87a to vibrate at the first vibration intensity according to the position to which the focus 202 is moved, and the right-side vibrator 87b to vibrate at the second vibration intensity according to the position. The more the focus 202 is moved to the left direction in the screen, the higher the drive control unit 130 sets the first vibration intensity of the left-side vibrator 87a and the lower the drive control unit 130 sets the second vibration intensity of the right-side vibrator 87b. In addition, the more the focus 202 is moved to the right direction in the screen, the higher the drive control unit 130 sets the second vibration intensity of the right-side vibrator 87b and the lower the drive control unit 130 sets the first vibration intensity of the left-side vibrator 87a. By controlling the vibration intensity as described above, the more the focus 202 is moved to the left direction in the screen, the stronger the vibration of the left-side vibrator 87a becomes and the weaker the vibration of the right-side vibrator 87b becomes, and conversely, the more the focus 202 is moved to the right direction in the screen, the stronger the vibration of the right-side vibrator 87b becomes and the weaker the vibration of the left-side vibrator 87a becomes. Thus, the user can recognize the movement and position of the focus 202 in the left-right direction.

In addition, the more the focus 202 is moved to the upper direction in the screen, the higher the drive control unit 130 sets the first vibration intensity of the left-side vibrator 87a and the second vibration intensity of the right-side vibrator 87b, and the more the focus 202 is moved to the lower direction in the screen, the lower the drive control unit 130 sets the first vibration intensity of the left-side vibrator 87a and the second vibration intensity of the right-side vibrator 87b. By controlling the vibration intensity as described above, the more the focus 202 is moved to the upper direction in the screen, the stronger the vibration of the left-side vibrator 87a and the vibration of the right-side vibrator 87b become, and conversely, the more the focus 202 is moved to the lower direction in the screen, the weaker the vibration of the left-side vibrator 87a and the vibration of the right-side vibrator 87b become. Thus, the user can recognize the movement and position of the focus 202 in the up-down direction.

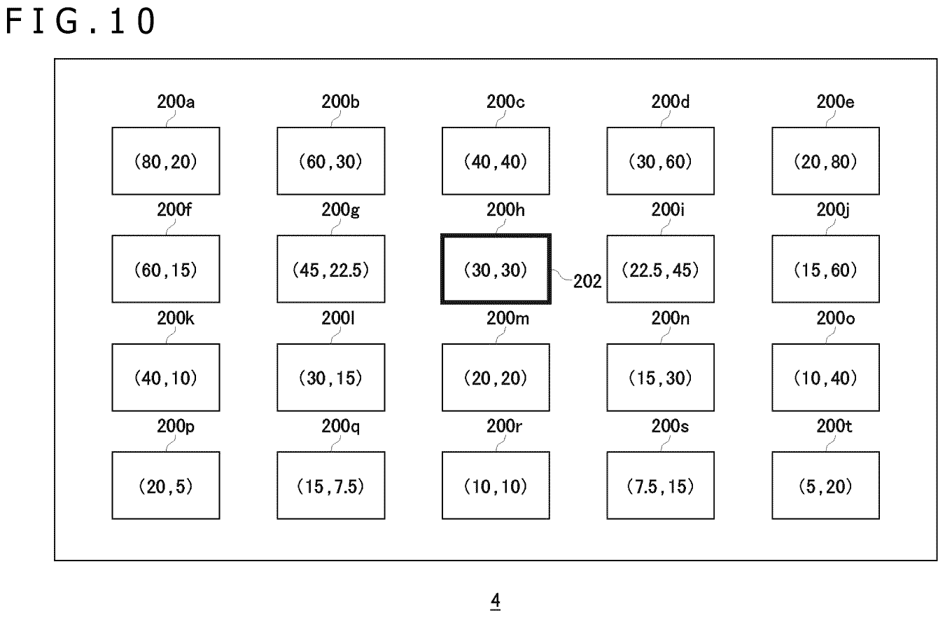

FIG. 10 illustrates examples of the vibration intensities of the left and right vibrators 87. In FIG. 10, “Ia” indicated on each icon 200 expresses the vibration intensity of the left-side vibrator 87a, and “Ib” expresses the vibration intensity of the right-side vibrator 87b. In this menu screen, the focus 202 is arranged to surround the icon 200h. Hereinafter, the vibration of the vibrator 87 when the direction keys 70 are operated from this state will be described.

When the left key 70d of the input device 6 is operated and the focus 202 is moved to the icon 200g, the drive control unit 130 generates control signals as intensities (45, 22.5) and transmits them from the communication unit 102 to the input device 6. That is, the drive control unit 130 generates a control signal for causing the left-side vibrator 87a to vibrate at a vibration intensity of 45 and a control signal for causing the right-side vibrator 87b to vibrate at a vibration intensity of 22.5, and transmits them from the communication unit 102 to the input device 6. The control unit 91 in the input device 6 controls the first driving unit 96a on the basis of the control signal for the left-side vibrator 87a to cause the left-side vibrator 87a to vibrate at a vibration intensity of 45, and controls the second driving unit 96b on the basis of the control signal for the right-side vibrator 87b to cause the right-side vibrator 87b to vibrate at a vibration intensity of 22.5. When the left-side holding part 80a and the right-side holding part 80b vibrate at the respective intensities, the user can recognize that the focus 202 has been moved to the icon 200g.

When the right key 70b of the input device 6 is operated and the focus 202 is moved to the icon 200i, the drive control unit 130 generates control signals as intensities (22.5, 45) and transmits them from the communication unit 102 to the input device 6. That is, the drive control unit 130 generates a control signal for causing the left-side vibrator 87a to vibrate at a vibration intensity of 22.5 and a control signal for causing the right-side vibrator 87b to vibrate at a vibration intensity of 45, and transmits them from the communication unit 102 to the input device 6. The control unit 91 in the input device 6 controls the first driving unit 96a on the basis of the control signal for the left-side vibrator 87a to cause the left-side vibrator 87a to vibrate at a vibration intensity of 22.5,and controls the second driving unit 96b on the basis of the control signal for the right-side vibrator 87b to cause the right-side vibrator 87b to vibrate at a vibration intensity of 45. When the left-side holding part 80a and the right-side holding part 80b vibrate at the respective intensities, the user can recognize that the focus 202 has been moved to the icon 200i.

When the upper key 70a of the input device 6 is operated and the focus 202 is moved to the icon 200c, the drive control unit 130 generates control signals as intensities (40, 40) and transmits them from the communication unit 102 to the input device 6. That is, the drive control unit 130 generates a control signal for causing the left-side vibrator 87a to vibrate at a vibration intensity of 40 and a control signal for causing the right-side vibrator 87b to vibrate at a vibration intensity of 40, and transmits them from the communication unit 102 to the input device 6. The control unit 91 in the input device 6 controls the first driving unit 96a on the basis of the control signal for the left-side vibrator 87a to cause the left-side vibrator 87a to vibrate at a vibration intensity of 40, and controls the second driving unit 96b on the basis of the control signal for the right-side vibrator 87b to cause the right-side vibrator 87b to vibrate at a vibration intensity of 40. When the left-side holding part 80a and the right-side holding part 80b vibrate at the respective intensities, the user can recognize that the focus 202 has been moved to the icon 200c.

When the lower key 70c of the input device 6 is operated and the focus 202 is moved to the icon 200m, the drive control unit 130 generates control signals as intensities (20, 20) and transmits them from the communication unit 102 to the input device 6. That is, the drive control unit 130 generates a control signal for causing the left-side vibrator 87a to vibrate at a vibration intensity of 20 and a control signal for causing the right-side vibrator 87b to vibrate at a vibration intensity of 20, and transmits them from the communication unit 102 to the input device 6. The control unit 91 in the input device 6 controls the first driving unit 96a on the basis of the control signal for the left-side vibrator 87a to cause the left-side vibrator 87a to vibrate at a vibration intensity of 20, and controls the second driving unit 96b on the basis of the control signal for the right-side vibrator 87b to cause the right-side vibrator 87b to vibrate at a vibration intensity of 20. When the left-side holding part 80a and the right-side holding part 80b vibrate at the respective intensities, the user can recognize that the focus 202 has been moved to the icon 200m.

The drive control unit 130 may cause the vibrator 87 to vibrate for a predetermined period of time (for example, 0.5 seconds) when the focus 202 is moved to another icon 200. It should be noted that, when the focus 202 is moved to the end of the array of the icons 200 and cannot be further moved even if the direction keys 70 are operated, the drive control unit 130 may cause the vibrator 87 to vibrate at a predetermined high intensity to inform the user that no further movement is possible. For example, the drive control unit 130 may generate a control signal as intensities (100, 100) to inform the user that no further movement is possible.

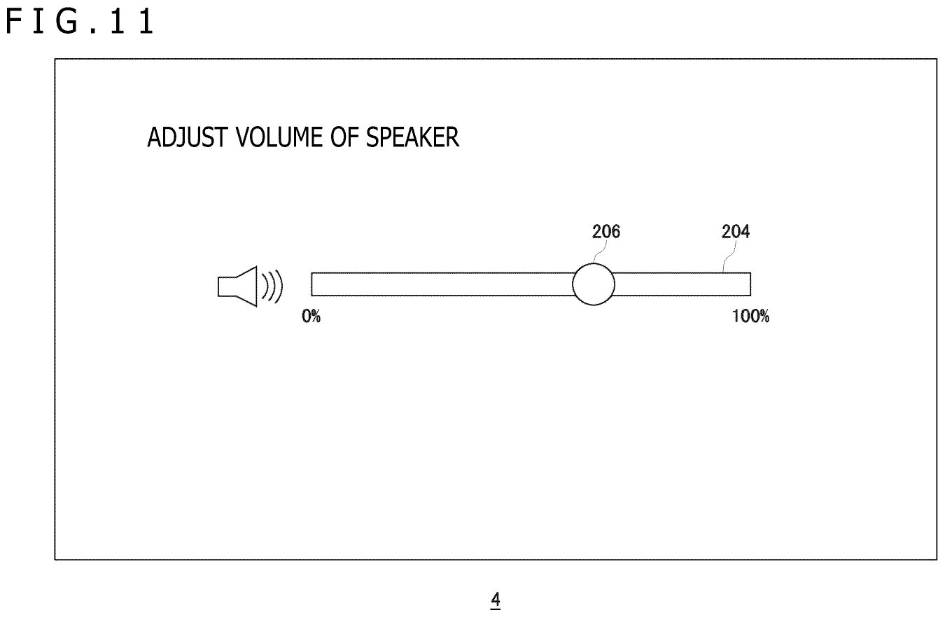

FIG. 11 illustrates another example of a UI screen presented to the user. In this example, the display control unit 142 displays a UI screen for adjusting the volume of the speaker on the output device 4. A bar 204 is displayed on the UI screen, and the focus control unit 124 arranges on the bar 204 a focus 206 indicating a selected position (volume) in the bar 204. The focus 206 is a slider, and the user adjusts the volume of the speaker by moving the focus 206 on the bar 204.

The drive control unit 130 may cause the left-side vibrator 87a and/or the right-side vibrator 87b to vibrate according to the moving direction and/or position of the focus 206.

For example, the drive control unit 130 may cause the left-side vibrator 87a to vibrate in the case where the focus 206 is moved to the left direction on the bar 204 and may cause the right-side vibrator 87b to vibrate in the case where the focus 206 is moved to the right direction on the bar 204.

In addition, the drive control unit 130 may cause the left-side vibrator 87a and the right-side vibrator 87b to vibrate according to the magnitude of the volume selected by the focus 206. For example, when the magnitude of the volume is 20%, the drive control unit 130 may generate a control signal as intensities (20, 20), and when the magnitude of the volume is 70%, the drive control unit 130 may generate a control signal as intensities (70, 70). In this case, the user can recognize the magnitude of the selected volume from the magnitudes of the vibrations of the left-side holding part 80a and the right-side holding part 80b.

In addition, the drive control unit 130 may cause the left-side vibrator 87a and the right-side vibrator 87b to vibrate, by using another standard. For example, when the magnitude of the volume is 20%, the drive control unit 130 may generate a control signal as intensities (80, 20), and when the magnitude of the volume is 70%, the drive control unit 130 may generate a control signal as intensities (30, 70). In this case, the user can recognize the magnitude of the selected volume from the difference between the magnitudes of the vibrations of the left-side holding part 80a and the right-side holding part 80b.

As the user interface screens operated by the user, the menu screen and the volume adjustment screen have been described above, but even in a screen keyboard screen for displaying a software keyboard, the drive control unit 130 may cause the left-side vibrator 87a and/or the right-side vibrator 87b to vibrate according to the movement and/or position of the focus 206.

It should be noted that the drive control unit 130 may set the vibration intensity of the vibrator 87 applied when the focus is moved, for each user interface screen. Specifically, the drive control unit 130 may differentiate the maximum value of the vibration intensity of the vibrator applied when the focus is moved, for each user interface screen. For example, the drive control unit 130 may set the maximum value of the vibration intensity of the vibrator 87 on the screen keyboard screen lower than the maximum value of the vibration intensity of the vibrator 87 on the menu screen. Since it is assumed that the focus is moved more frequently on the screen keyboard screen than on the menu screen, the vibration intensity may be set relatively low to avoid adding excessive tactile stimulation to the hands of the user.

As described above, in the menu screen illustrated in FIG. 7, when the decision button of the input device 6 is operated in a state where the focus 202 is given to the icon 200 of the game, the execution unit 140 executes the game program associated with the selected icon to generate a game image and a game voice, and the display control unit 142 causes the game image and the game voice to be output from the output device 4.

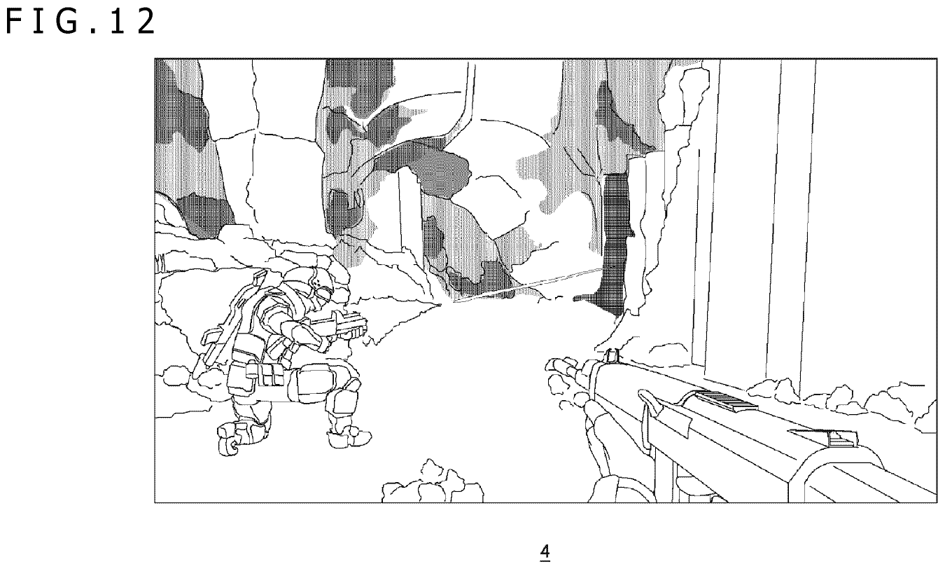

FIG. 12 illustrates an example of a game screen displayed on the output device 4. The user operates the input device 6 while viewing the game screen to advance the game.

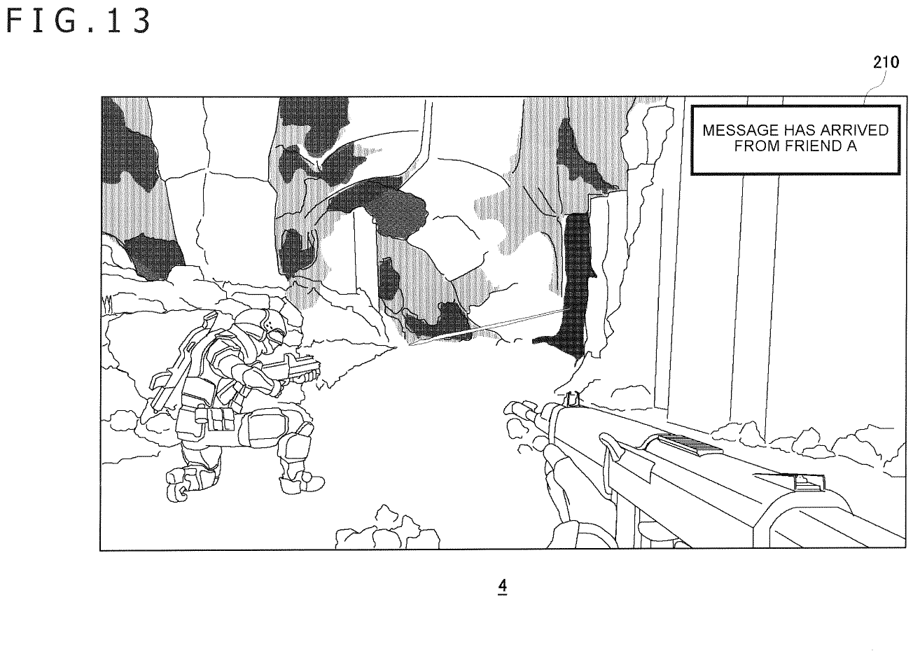

FIG. 13 illustrates an example of a notification message 210 superimposed and displayed on the game screen. When the communication unit 102 receives a message from a server connected to an external network during the game play of the user, the display control unit 142 superimposes and displays the notification message 210 on the game screen. When the notification message 210 is superimposed and displayed, the drive control unit 130 may cause the left-side vibrator 87a and/or the right-side vibrator 87b to vibrate to inform the user that the notification message 210 has arrived.

As described above, the information processing device 10 has a function of causing the vibrator 87 of the input device 6 to vibrate, regarding the display of the user interface. In the embodiment, the vibrator 87 is provided for the purpose of providing feedback to the user in the game play, so that the vibration function related to the user interface can be utilized on the assumption that the vibration function related to the game play is enabled. Hereinafter, a procedure for enabling the vibration function related to the user interface will be described.

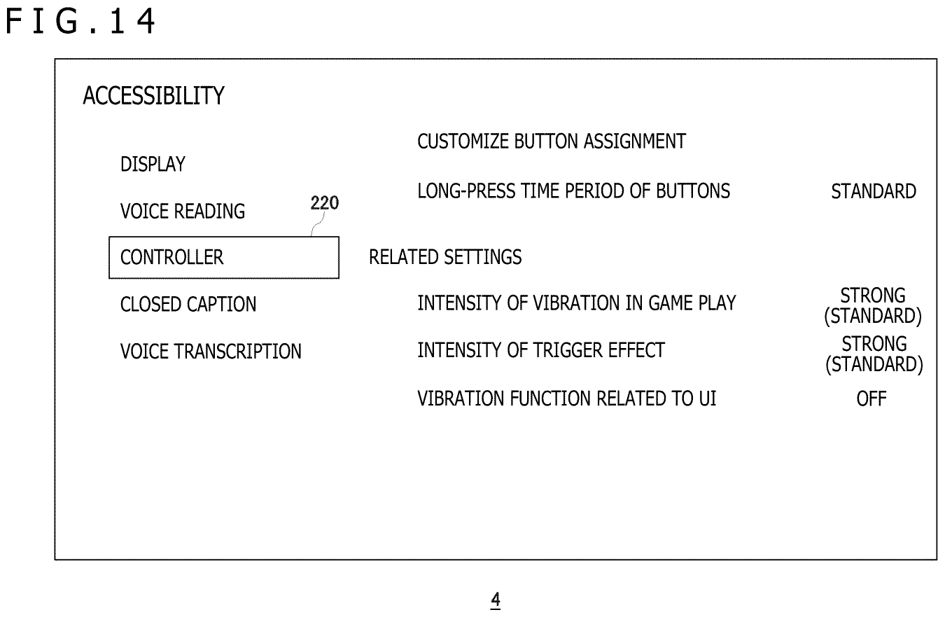

FIG. 14 illustrates an example of a setting screen of accessibility. When the reception unit 110 receives a display request of the accessibility setting screen from the user, the display control unit 142 displays the accessibility setting screen on the output device 4. On the left side in the setting screen, displayed are items of “display,” “voice reading,” “controller,” “closed caption,” and “voice transcription,” a selection frame 220 is arranged at the item of the “controller,” and items related to the accessibility of the controller are displayed in a display area on the right side. The setting storage unit 160 holds (stores) setting contents related to the accessibility of the controller.

The setting storage unit 160 holds setting contents of customized button assignment, setting contents for s long-press time period of buttons, information indicating that the vibration function related to the game play is enabled or disabled, information indicating that a trigger effect function is enabled or disabled, and information indicating that the vibration function related to the UI is enabled or disabled. In this example, the setting storage unit 160 holds information indicating that the vibration function related to the game play is enabled and the vibration intensity is “strong,” information indicating that the trigger effect function is enabled and the effect intensity is “strong,” and information indicating that the vibration function related to the UI is disabled.

Since “vibration function related to UI” is set to off, the user who wants to enable the vibration function related to the user interface operates the input device 6 to make an input to enable the vibration function related to the user interface.

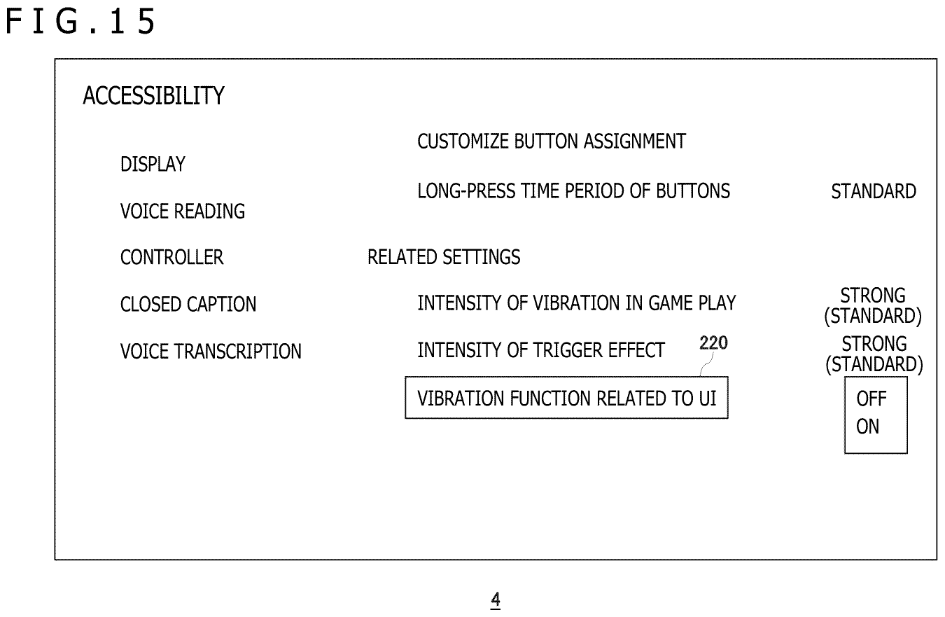

FIG. 15 illustrates an example of a screen for enabling the vibration function related to the user interface. When the user arranges the selection frame 220 at “vibration function related to UI,” the display control unit 142 presents options for turning on or off the vibration function related to the user interface. Here, when the user operates the input device 6 to move the selection frame 220 to “on” and operates the decision button, the reception unit 110 receives the user operation to enable the vibration function related to the user interface. At this time, the UI vibration setting unit 154 enables the vibration function related to the user interface on the condition that the setting storage unit 160 holds information indicating that the vibration function related to the game play is enabled.

Here, in the setting state illustrated in FIG. 15, the vibration function related to the game play is set to ON, and therefore, the setting storage unit 160 holds information indicating that the vibration function related to the game play is enabled. Then, the UI vibration setting unit 154 sets the vibration function related to the user interface to be enabled, and stores the information indicating that the vibration function related to the user interface is enabled in the setting storage unit 160. By enabling the vibration function related to the user interface as described above, the drive control unit 130 can cause the vibrator 87 to vibrate when the user interface is displayed.

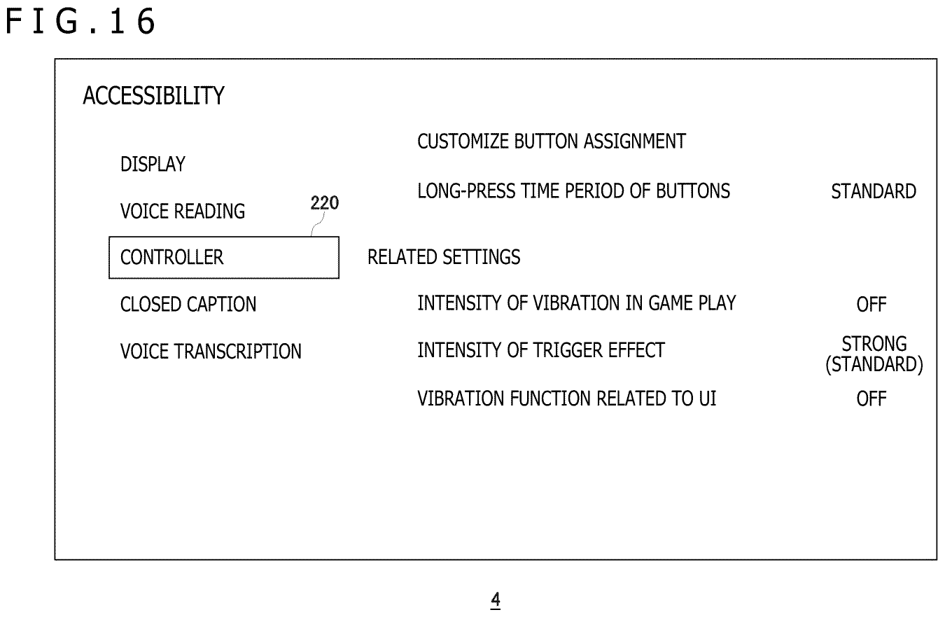

FIG. 16 illustrates another example of the accessibility setting screen. In comparison with the setting screen illustrated in FIG. 14, in the setting screen illustrated in FIG. 16, the vibration function related to the game play is set to OFF, that is, the setting storage unit 160 holds information indicating that the vibration function related to the game play is disabled. In this state, the user who wants to enable the vibration function related to the user interface operates the input device 6 to make an input to enable the vibration function related to the user interface.

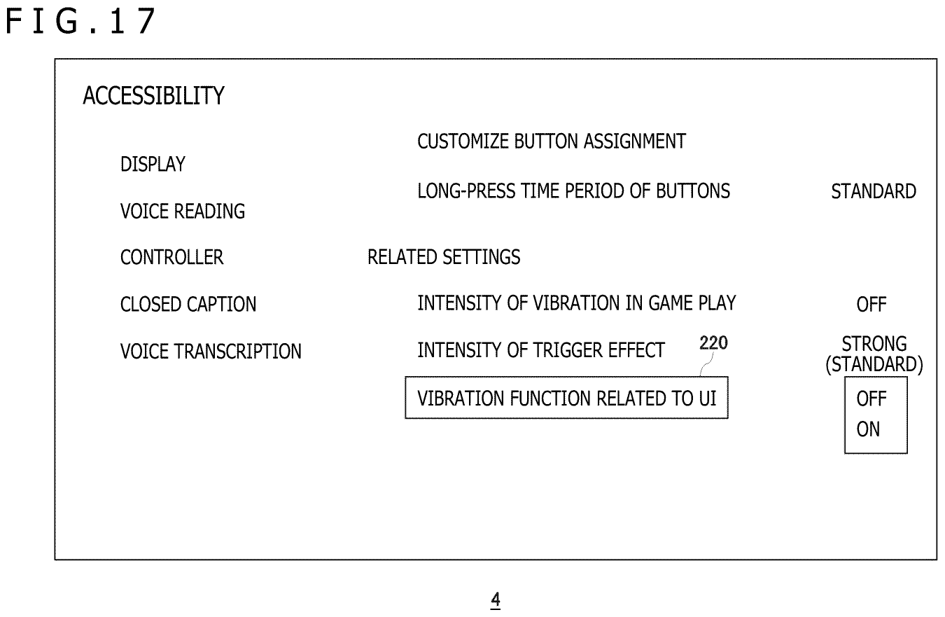

FIG. 17 illustrates an example of a screen for enabling the vibration function related to the user interface. When the user arranges the selection frame 220 at “vibration function related to UI,” the display control unit 142 presents options for turning on or off the vibration function related to the user interface. Here, when the user operates the input device 6 to move the selection frame 220 to “on” and operates the decision button, the reception unit 110 receives the user operation to enable the vibration function related to the user interface. As described above, the UI vibration setting unit 154 can enable the vibration function related to the user interface on the condition that the setting storage unit 160 holds information indicating that the vibration function related to the game play is enabled.

Here, in the setting state illustrated in FIG. 17, the vibration function related to the game play is set to OFF, and therefore, the setting storage unit 160 holds information indicating that the vibration function related to the game play is disabled. The UI vibration setting unit 154 does not enable the vibration function related to the user interface in the case where the setting storage unit 160 holds information indicating that the vibration function related to the game play is disabled. That is, the UI vibration setting unit 154 does not change the information that is stored in the setting storage unit 160 and that indicates that the vibration function related to the user interface is disabled.

At this time, the UI vibration setting unit 154 may generate a dialog for enabling the vibration function related to the game play.

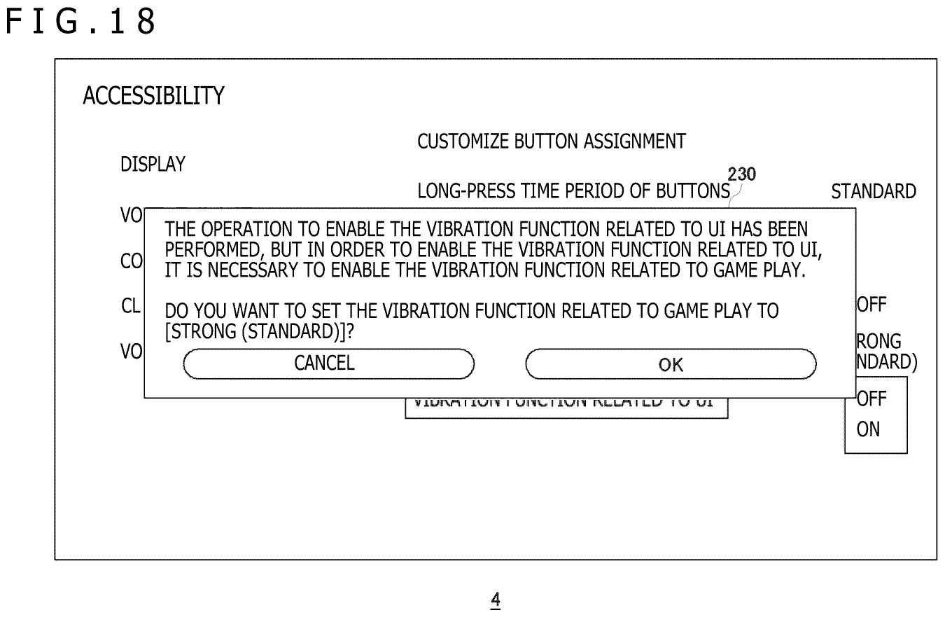

FIG. 18 illustrates an example of a dialog 230 superimposed and displayed on the setting screen. Since the vibration function related to the game play needs to be enabled in order to enable the vibration function related to the user interface, the UI vibration setting unit 154 generates the dialog 230 for enabling the vibration function related to the game play for the user, and the display control unit 142 superimposes and displays the dialog 230 on the setting screen.

When the user operates an OK button of the dialog 230, the game vibration setting unit 152 enables the vibration function related to the game play. Specifically, the game vibration setting unit 152 stores in the setting storage unit 160 information indicating that the vibration function related to the game play is enabled and the vibration intensity is “strong.” As described above, after the game vibration setting unit 152 enables the vibration function related to the game play, the UI vibration setting unit 154 may enable the vibration function related to the user interface.

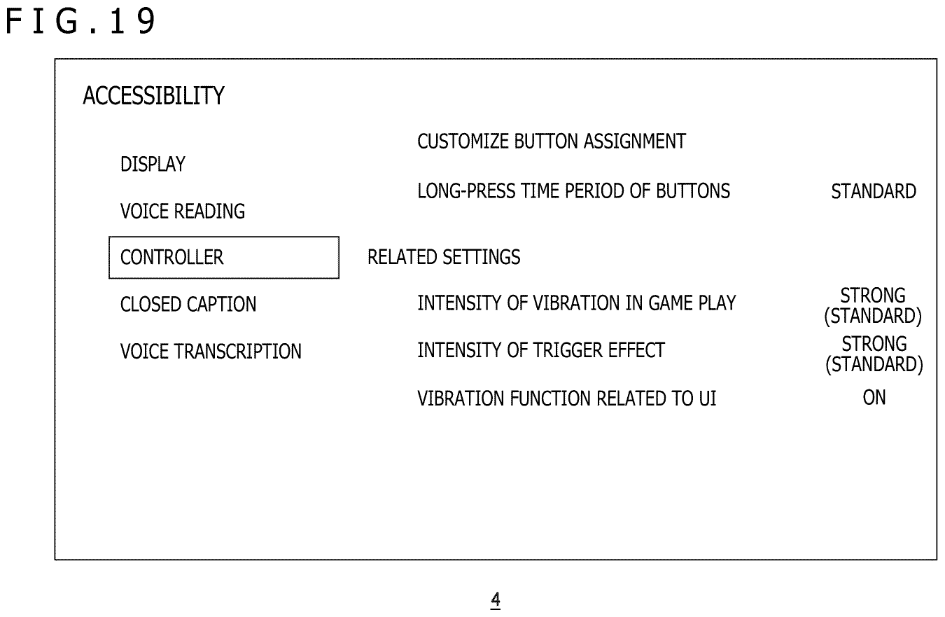

FIG. 19 illustrates an example of a setting screen in which the vibration function related to the user interface is enabled. As described above, by enabling the vibration function related to the user interface, the drive control unit 130 can cause the vibrator 87 to vibrate during the display of the user interface.

It should be noted that, in the case where the vibration function related to the user interface is enabled, the UI vibration setting unit 154 may disable part of the vibration function related to the user interface on the basis of the user operation. For example, although the notification message 210 is superimposed and displayed on the game screen during the game play (see FIG. 13), if the drive control unit 130 causes the vibrator 87 to vibrate at this time, there is a possibility that the user mistakes the vibration for the feedback from the game. Therefore, the user may set the vibration function to be disabled when the notification message 210 is displayed. It should be noted that the user may disable the vibration function, for example, on the screen keyboard screen, not only when the notification message is displayed. In the case where the user has enabled the vibration function related to the user interface in this way, it is preferable that the user can optionally select a situation in which no vibration is necessary and disable the vibration function in the selected situation.

The present disclosure has been described above on the basis of the embodiment. It can be understood by those skilled in the art that this embodiment is illustrative, various modified examples are possible for combinations of each constitutional element and each processing process thereof, and such modified examples are also within the scope of the present disclosure. In the embodiment, the input device 6 includes the vibrator 87, but other types of electronic equipment without an input function may include the vibrator 87.

The present disclosure can be used in the technical field of controlling vibration of a vibrator.

What is claimed is:

1. An information processing device that is connected, in a wireless or wired manner, to an input device including a left-side holding part having a left-side vibrator and a right-side holding part having a right-side vibrator, the information processing device comprising:
one or more processors having hardware,
wherein the one or more processors arrange a focus in a screen, receive directional input transmitted from the input device, move the focus on a basis of the received directional input, and cause the left-side vibrator and/or the right-side vibrator to vibrate according to the movement of the focus.

2. The information processing device according to claim 1, wherein the one or more processors cause the left-side vibrator and/or the right-side vibrator to vibrate according to a moving direction of the focus.

3. The information processing device according to claim 2, wherein the one or more processors cause the left-side vibrator to vibrate in a case where the focus is moved to a left direction in the screen and cause the right-side vibrator to vibrate in a case where the focus is moved to a right direction in the screen.

4. The information processing device according to claim 2, wherein the one or more processors cause the left-side vibrator and the right-side vibrator to vibrate at a first vibration intensity in a case where the focus is moved to an upper direction in the screen, and cause the left-side vibrator and the right-side vibrator to vibrate at a second vibration intensity different from the first vibration intensity in a case where the focus is moved to a lower direction in the screen.

5. The information processing device according to claim 1, wherein the one or more processors cause the left-side vibrator to vibrate at a first vibration intensity according to a position to which the focus is moved, and cause the right-side vibrator to vibrate at a second vibration intensity according to the position.

6. The information processing device according to claim 5, wherein, the more the focus is moved to a left direction in the screen, the higher the one or more processors set the first vibration intensity of the left-side vibrator and the lower the one or more processors set the second vibration intensity of the right-side vibrator, and the more the focus is moved to a right direction in the screen, the higher the one or more processors set the second vibration intensity of the right-side vibrator and the lower the one or more processors set the first vibration intensity of the left-side vibrator.

7. The information processing device according to claim 5, wherein, the more the focus is moved to an upper direction in the screen, the higher the one or more processors set the first vibration intensity of the left-side vibrator and the second vibration intensity of the right-side vibrator, and the more the focus is moved to a lower direction in the screen, the lower the one or more processors set the first vibration intensity of the left-side vibrator and the second vibration intensity of the right-side vibrator.

8. The information processing device according to claim 1, wherein the one or more processors arrange the focus at one selected display element among a plurality of display elements displayed on the screen and move the focus to another display element on the basis of the received directional input.

9. The information processing device according to claim 1, wherein the one or more processors arrange a slider indicating a selected position as a focus on a bar displayed on the screen.

10. The information processing device according to claim 1, wherein the one or more processors differentiate a maximum value of a vibration intensity of the vibrators applied when the focus is moved on a first screen from a maximum value of the vibration intensity of the vibrators applied when the focus is moved on a second screen.

11. A method of controlling vibration of a vibrator in an information processing device that is connected, in a wireless or wired manner, to an input device including a left-side holding part having a left-side vibrator and a right-side holding part having a right-side vibrator, the method comprising:
arranging a focus in a screen;
receiving directional input transmitted from the input device;
moving the focus on a basis of the received directional input; and
causing the left-side vibrator and/or the right-side vibrator to vibrate according to the movement of the focus.

12. An information processing device that is connected, in a wireless or wired manner, to electronic equipment including a vibrator, the information processing device comprising:
a storage unit that holds information indicating whether a vibration function related to a game play is enabled or disabled; and
one or more processors having hardware, wherein the one or more processors receive a user operation to enable a vibration function related to a user interface, enable the vibration function related to the user interface if the information indicating that the vibration function related to the game play is enabled is held in the storage unit, and cause the vibrator to vibrate when the user interface is displayed.

13. The information processing device according to claim 12, wherein, when receiving the user operation to enable the vibration function related to the user interface, if the information indicating that the vibration function related to the game play is disabled is held in the storage unit, the one or more processors do not enable the vibration function related to the user interface.

14. The information processing device according to claim 12, wherein, when receiving the user operation to enable the vibration function related to the user interface, if the information indicating that the vibration function related to the game play is disabled is held in the storage unit, the one or more processors display a dialog to enable the vibration function related to the game play.

15. The information processing device according to claim 14, wherein the one or more processors enable the vibration function related to the user interface after the vibration function related to the game play is enabled.

16. The information processing device according to claim 12, wherein the one or more processors disable part of the vibration function related to the user interface on a basis of the user operation in a case where the vibration function related to the user interface is enabled.

17. A method of controlling vibration of a vibrator in an information processing device that is connected, in a wireless or wired manner, to electronic equipment including the vibrator, the method comprising:
holding information indicating whether a vibration function related to a game play is enabled or disabled;
receiving a user operation to enable a vibration function related to a user interface;
if the information indicating that the vibration function related to the game play is enabled is held, enabling the vibration function related to the user interface; and
causing the vibrator to vibrate when the user interface is displayed.
